(19) United States
(12) Patent Application Publication
(10) Pub. No.: US 2011/0093541 A1
(43) Pub. Date: Apr. 21, 2011

(54) APPARATUS AND METHOD FOR SUPPRESSING A DEVICE MANAGEMENT (DM) MESSAGE IN A COMMUNICATION SYSTEM

(75) Inventors: Kong Posh Bhat, Plano, TX (US); Nhut Nguyen, Richardson, TX (US); Mark Trayer, Plano, TX (US)

(73) Assignee: SAMSUNG ELECTRONICS CO. LTD., Suwon-si (KR)

(21) Appl. No.: 12/580,848

(22) Filed: Oct. 16, 2009

(51) Int. Cl. G06F 15/16

(52) U.S. Cl. 709/206

(57) ABSTRACT

Device Management (DM) client apparatus and DM server apparatus and methods for their operation in a communication system are provided. The method for operating the DM client apparatus in a communication system includes receiving a message from a DM server, determining if a response message should be suppressed based on the received message, if it is determined that the response message should be suppressed, suppressing the response message by not transmitting the response message to the DM server, if it is not determined that the response message should be suppressed, transmitting the response message to the DM server, and receiving another message from the DM server.

### BACKGROUND OF THE INVENTION

1. Field of the Invention

The present invention relates to Device Management (DM) messaging in a communication system. More particularly, the present invention relates to a technique for suppressing a DM message in a communication system.

2. Description of the Related Art

With the growth in ubiquitous communications technologies and systems, devices are increasing in functionality and complexity. However, with the increase in the functionality and complexity of the devices, a need for the management of the devices has developed. To address that need, the Open Mobile Alliance (OMA) established a Device Management (DM) Working Group to specify protocols and mechanisms that achieve management of devices. The OMA DM Working Group has developed the OMA-DM specification, which defines a two-way protocol between a DM server and a DM client associated with a device that is used for remote management of the device. An instance of DM is referred to as a DM session and may be initiated by either the DM client or the DM server. Historically, the devices have been wireless devices, but of late, OMA-DM has begun addressing the remote management needs of wired devices as well. Examples of OMA-DM include the setting of initial configuration information in devices, the subsequent installation and update of persistent information in devices, the retrieval of management information from devices, and the processing of events and alarms generated by devices.

An example of a communication system employing OMA-DM is described below with reference to FIG. 1.

FIG. 1 illustrates an exemplary communication system employing OMA-DM according to the conventional art.

Referring to FIG. 1, the exemplary communication system employing OMA-DM may include a wired network 100, a wireless network 102, a wired device 110, a wireless device 112, a DM server 120, and a DM authority 130. Each of the wired device 110 and the wireless device 112 has associated therewith a DM client (not shown). In addition, the DM authority 130 may be an Operations Support System (OSS). In FIG. 1, solid lines represent physical connectivity and dotted lines represent logical connectivity.

The exemplary communication system employing OMA-DM illustrated in FIG. 1 is merely one of a number of possible implementations. For example, one of the wired network 100 and the wireless network 102 may be omitted. Alternatively, the wired network 100 and the wireless network 102 may be combined. Further, while the DM server 120 and the DM authority 130 are shown as connected to the wired network 100, one or both of the DM server 120 and the DM authority 130 may alternatively be connected to the wireless network 102.

To facilitate OMA-DM in the communication system illustrated in FIG. 1, a two-way protocol based on the OMA-DM specification is utilized between the DM server 120 and the DM client associated with wireless device 112, and between the DM server 120 and the DM client associated with the wired device 110. The DM authority 130 may direct the DM operations of the DM client associated with each of the wired device 110 and wireless device 112 via the DM server 120. Only the interaction between the DM server 120 and a DM client associated with each of the wired device 110 and wireless device 112, is within the scope of the OMA-DM specification.

An example of a DM server initiated DM session with a DM client is described below with reference to FIG. 2.

FIG. 2 is a signal diagram for a DM server initiated DM session with a DM client in a communication system according to the conventional art.

Referring to FIG. 2, the DM server initiated DM session between the DM server 202 and the DM client 204 includes two phases. The first phase is a setup phase 210 and the second phase is a management phase 220. The setup phase 210 includes an exchange of information for authentication and device information. The exchange of information in the setup phase 210 includes three messages, namely a Package 0 message 212, a Package 1 message 214, and a Package 2 message 216. The Package 0 message 212 is a message sent from DM server 202 to DM client 204 that includes alert information. The Package 1 message 214 is a message sent from DM client 204 to DM server 202. The Package 1 message 214 includes client initialization information and device information. The client initialization information includes client credentials. The Package 2 message 216 is a message sent from DM server 202 to DM client 204. The Package 2 message 216 includes server initialization information and at least one of an initial management operation and one or more user interaction commands. The server initialization information includes one or more server credentials.

The management phase 220 includes two messages, namely a Package 3 message 222, and a Package 4 message 224. The Package 3 message 222 is a message sent from DM client 204 to DM server 202. The Package 3 message 222 includes client response information to the management operation triggered by the Package 2 message 216. The Package 4 message 224 is a message sent from DM server 202 to DM client 204. The Package 4 message 224 includes at least one of an additional management operation and one or more additional user interaction commands, if the DM session is continued beyond the Package 2 message 216. Additional cycles of a Package 3 message 222 and a Package 4 message 224 may be transmitted between the DM server 202 and DM client 204 until the DM session is terminated.

However, the DM server initiated DM session described above with reference to FIG. 2 was developed under the OMA-DM specification in the context of unicast communication. Recently, the OMA, under the aegis of the DM-BroadCAST (BCAST) Birds-of-a-Feather (BoF) interest group, studied the problem of simultaneously executing DM commands in a broadcast mode on a large number of devices. An exemplary communication system employing DM-BCAST is similar to the communication system described above with reference to FIG. 1. However, a communication system employing DM-BCAST includes a BCAST server (not shown). In operation, a DM command to be communicated via BCAST originates at the DM server, is transmitted to a BCAST server, and is then transmitted to a plurality of devices. There are a few situations where targeting DM commands on a large number of devices may be beneficial. Such situations include firmware/software updates, audience/network measurements, and device capability control.

When targeting a large number of DM clients in a broadcast setting, there is a need to eliminate (or minimize) response messages from the DM clients to the DM server. If the response messages from the DM client to the DM server are not eliminated (or minimized) in the broadcast setting, the DM server would be overwhelmed with the large number of simultaneous messages from the targeted DM clients. As illustrated in FIG. 2, in a DM server initiated DM session, there are two types of response messages that a DM client transmits back to the DM server, namely a Package 1 message and a Package 3 message. Several options for suppressing/delaying the Package 3 message are under active investigation. These options include a random back-off based response mechanism as well as a new reporting management object that controls the status reporting criteria at the DM client. Examples of the reporting criteria include report only on failure, report always, report never (and store the status in a DM Tree for later retrieval), etc. However, no viable solution has emerged for the problem of suppressing the Package 1 message.

Therefore, a need exists for a technique for suppressing an OMA-DM Package 1 message in a communication system.

### SUMMARY OF THE INVENTION

An aspect of the present invention is to address at least the above-mentioned problems and/or disadvantages and to provide at least the advantages described below. Accordingly, an aspect of the present invention is to provide a technique for suppressing a Device Management (DM) message in a communication system.

In accordance with an aspect of the present invention, a method for operating a DM client in a communication system is provided. The method includes receiving a message from a DM server, determining if a response message should be suppressed based on the received message, if it is determined that the response message should be suppressed, suppressing the response message by not transmitting the response message to the DM server, if it is not determined that the response message should be suppressed, transmitting the response message to the DM server, and receiving another message from the DM server.

In accordance with another aspect of the present invention, a method for operating a DM server in a communication system is provided. The method includes determining to initiate a DM session with a DM client, determining if the DM client should be instructed to suppress a response message, if it is determined that the DM client should be instructed to suppress a response message, generating a message that includes an instruction for the DM client to suppress the response message, if it is not determined that the DM client should be instructed to suppress a response message, generating a message that does not include an instruction for the DM client to suppress the response message, and transmitting the generated message.

In accordance with yet another aspect of the present invention, a DM client apparatus for use in a communication system is provided. The apparatus includes a receiver for receiving one or more messages from a DM server, a transmitter for transmitting a response message to the a DM server, wherein the response message is transmitted in response to a message received from the DM server, and a message suppression determiner for determining if the response message should be suppressed based on the received message, wherein if the message suppression determiner determines that the response message should be suppressed, the transmitter does not transmit the response message to the DM server, and if the message suppression determiner does not determine that the response message should be suppressed, the transmitter transmits the response message to the DM server.

In accordance with still another aspect of the present invention, a DM server apparatus for use in a communication system is provided. The apparatus includes a DM session initiation determiner for determining to initiate a DM session with a DM client, a receiver for receiving a response message from the DM client, a message suppression determiner for determining if the DM client should be instructed to suppress the response message, a message generator for generating one or more messages for transmission to the DM client, and a transmitter for transmitting the generated message to the DM client, wherein if the message suppression determiner determines that the DM client should be instructed to suppress the response message, the message generator generates a message that includes an instruction for the DM client to suppress the response message, and if the message suppression determiner does not determine that the DM client should be instructed to suppress the response message, the message generator generates a message that does not include an instruction for the DM client to suppress the response message.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an exemplary communication system employing Open Mobile Alliance (OMA)-Device Management (DM) according to the conventional art;

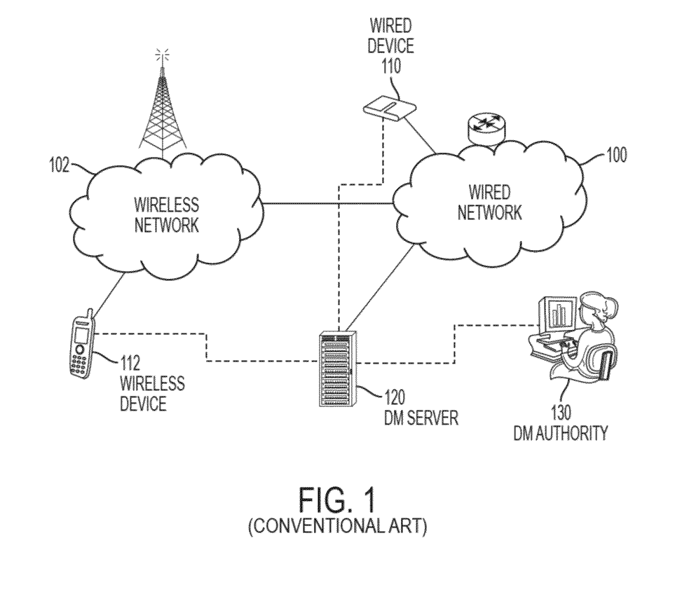

FIG. 2 is a signal diagram for a DM server initiated DM session with a DM client in a communication system according to the conventional art;

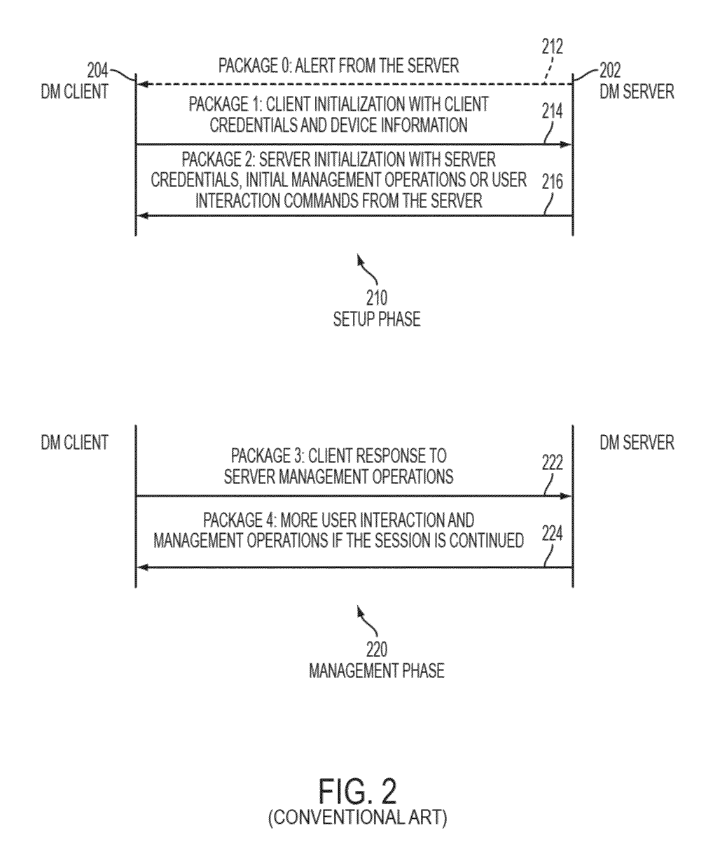

FIG. 3 is a flowchart illustrating a method for selectively suppressing an OMA-DM Package 1 message at a DM client in communication system according to an exemplary embodiment of the present invention;

FIG. 4 is a flowchart illustrating a method for selectively suppressing an OMA-DM Package 1 message at a DM server in communication system according to an exemplary embodiment of the present invention;

FIG. 5 is a block diagram of a device including a DM client for selectively suppressing an OMA-DM Package 1 message in a communication system according to an exemplary embodiment of the present invention; and

FIG. 6 is a block diagram of a computing apparatus including a DM server for selectively suppressing an OMA-DM Package 1 message in a communication system according to an exemplary embodiment of the present invention;

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to a technique for suppressing a Device Management (DM) message in a communication system. While the technique for suppressing a DM message is described below in the context of an Open Mobile Alliance (OMA)-DM message, the present invention is similarly applicable to the suppression of other messages. Further, while the technique for suppressing DM a message is described hereafter in the context of broadcast, such as OMA-BroadCAST (BCAST), the present invention is similarly applicable in a non-broadcast scenario, such as unicast.

It should be understood that the following description may refer to terms utilized in various standards merely for simplicity of explanation. For example, the following description may refer to terms utilized in one of the OMA standards, such as the OMA-DM or OMA-BCAST standards. However, this description should not be interpreted as being limited to such standards. Independent of the mechanism used to suppress a DM message, it is preferable that a DM message be suppressed and it is advantageous for that ability to conform to a standardized mechanism.

Exemplary embodiments of the present invention suppress a DM message of a setup phase of a DM server initiated DM session, and more specifically, an OMA-DM Package 1 message of a DM server initiated DM session. Accordingly, for ease of explanation, the discussion provided below will be limited to the setup phase of a DM server initiated DM session. However, it is contemplated that the exemplary embodiments of the present invention will operate with any conventional management phase (i.e. communication of at least one of OMA-DM Package and OMA-DM Package 4 messages) of a DM server initiated DM session.

Described below is a technique for selectively suppressing an OMA-DM Package 1 message of a DM server initiated DM session in a communication system according to exemplary embodiments of the present invention. The technique for selectively suppressing an OMA-DM Package 1 message of a DM server initiated DM session may be used when simultaneously executing DM commands in a broadcast mode on a large number of DM clients.

The OMA-DM Package 1 of a DM server initiated DM session contains client credentials for DM authentication and device information such as a device IDentifier (ID), a device model, a device manufacturer, etc. The device information that is sent by the DM client to the DM server in the Package 1 message is fairly static and therefore transmitting the Package 1 message in every DM session may be redundant. Accordingly, it may not be necessary to transmit the Package 1 message in every DM session.

The OMA-DM protocol allows the DM client and the DM server to bypass DM authentication if Secure Transport (ST) authentication is used. Accordingly, the Package 1 message can be suppressed if ST authentication is employed. OMA-BCAST is a secure transport (ST) mechanism, and therefore DM authentication may be bypassed without violating the OMA-DM protocol.

Exemplary embodiments of the present invention selectively suppress an OMA-DM Package 1 message that are transmitted from the DM client to the DM server when two conditions are met, namely, when the DM session is initiated by the DM server, and when the underlying transport protocol supports ST authentication. Both of these conditions are met for DM over BCAST (i.e. DM-BCAST).

Hereafter, exemplary embodiments of the present invention will be described in the context of DM-BCAST, where a message that originates at a DM server for one or more DM clients passes through a BCAST server for transmission to the one or more DM clients. However, for ease in explanation, descriptions of the message passing through the BCAST server will be omitted. In addition, the present invention is not limited to operation in the context of DM-BCAST and may be utilized in the context of unicast. Here, a message that originates at a DM server for a DM client is transmitted to the DM client without passing through a BCAST server.

In an exemplary implementation, the Package 1 message is suppressed based on information disposed in an OMA-DM Package 0 message. The Package 0 message is transmitted by the DM server to the DM client to initiate a DM session. The Package 0 message includes the following fields:

Device Management Version identifier

User Interaction Mode

Initiator of Management Action

Reserved Field for future use

Session Identifier

Length Identifier

Server Identifier

Vendor Specific Information

Of the above-identified fields of the Package 0 message, the Reserved Field, in an exemplary implementation, is used by the DM server to instruct the DM client to suppress the Package 1 message. The DM server instructs the DM client using a flag in the Package 0 message. The flag that indicates if a Package 1 message should be suppressed will hereafter be referred to as a suppression flag.

In version 1.2 of the OMA-DM standard, the reserved field is a 27-bit field, whose value is 0. In an exemplary embodiment of the present invention, 1-bit from this 27-bit field is used as the suppression flag. One of the binary values for the suppression flag (i.e. the suppression flag bit) indicates that DM client should not suppress the Package 1 message. Here, the binary value for the suppression flag bit to indicate that the DM client should not suppress the Package 1 message may be a value of ‘0’. The value of ‘0’ may hereafter be referred to as false. However, the other binary value for the suppression flag bit indicates that the DM client shall suppress the transmission of the Package 1 message to the DM server, subject to the condition that ST authentication is employed. Here, the binary value for the suppression flag bit to indicate that the DM client should not suppress the Package 1 message may be a value of ‘1’V. The value of ‘1’ may hereafter be referred to as true. The DM client may determine if ST authentication is used by determining if a value of an AAuthType node in a DM Account Management Object (MO) for the corresponding DM server in a DM Tree is set to ‘TRANSPORT’. If the value of the AAuthType node for the corresponding DM server is set to ‘TRANSPORT’, it indicates that ST authentication is employed and that no additional authentication mechanisms need be utilized. The DM Account MO is a conventional MO that includes information pertaining to all DM Servers to which the DM client has been bootstrapped.

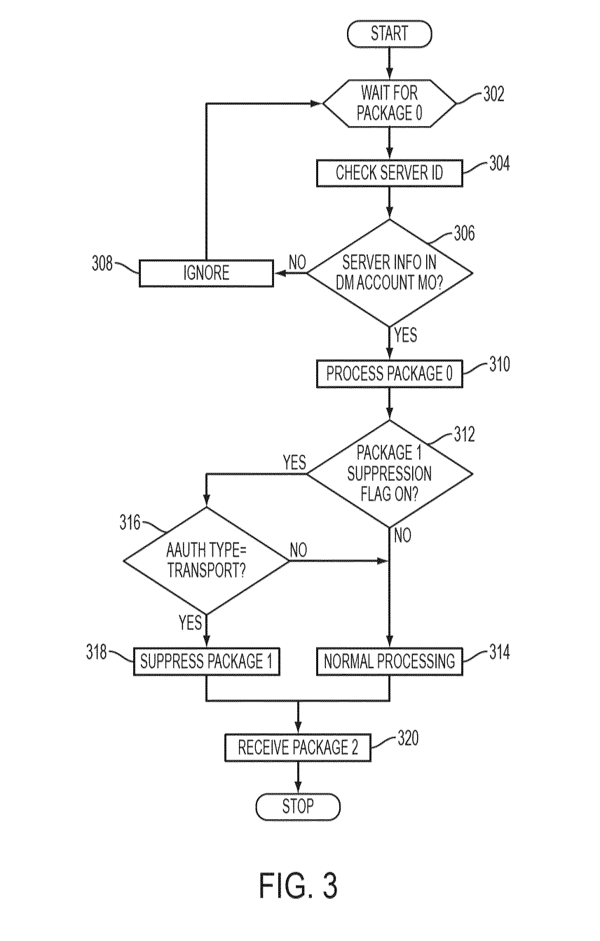

A method of selectively suppressing an OMA-DM Package 1 message at a DM client is described below with reference to FIG. 3.

FIG. 3 is a flowchart illustrating a method for selectively suppressing an OMA-DM Package 1 message at a DM client in communication system according to an exemplary embodiment of the present invention.

Referring to FIG. 3, the DM client waits for a Package 0 message from a DM server in step 302. Receipt of the Package 0 message from the DM server begins a setup phase of a DM session according to an exemplary embodiment of the present invention. Upon receiving the Package 0 message from the DM server, the DM client extracts a DM server ID from the received Package 0 message in step 304. In step 306, the DM client determines if the DM server ID is a DM server ID that corresponds to a recognized DM server by determining if the DM server ID matches with an instance of a DM Account MO in a DM Tree. If it is determined that the DM server ID does not correspond to a recognized DM server, the received Package 0 message is ignored in step 308 and the process returns to step 302. If it is determined that the DM server ID corresponds to a recognized DM server, the Package 0 message is processed in step 310.

In step 312, the DM client determines the value of the suppression flag, which is located in the Reserved field of the Package 0 message, and indicates whether to suppress a Package 1 message. If it is determined that the suppression flag is set to false (e.g. ‘0’), the DM client proceeds to step 314. In step 314, the DM client transmits the Package 1 message to the DM server. In step 320, the DM client receives a Package 2 message from the DM server. Thereafter, the process ends and a conventional management phase of the DM session may be performed.

If it is determined in step 312 that the suppression flag is set to true (e.g. ‘1’), the DM client proceeds to step 316. In step 316, the DM client determines if the value of the AAuthType node for the corresponding DM server in the DM Account MO is set to ‘TRANSPORT.’ If it is determined that the value of the AAuthType node for the corresponding DM server is set to ‘TRANSPORT,’ it indicates that ST authentication is employed. If it is determined that the value of the AAuthType node for the corresponding DM server is not set to ‘TRANSPORT,’ the process proceeds to step 314 where the DM client transmits the Package 1 message to the DM server. Here, the DM client transmits the Package 1 message to the DM server despite the instruction by the DM server to suppress the Package 1 message because ST authentication is not employed. In step 320, the DM client receives the Package 2 message from the DM server. Thereafter, the process ends and a conventional management phase of the DM session may be performed.

Returning to step 316, if it is determined that the value of the AAuthType node for the corresponding DM server is set to ‘TRANSPORT’, the process proceeds to step 318. In step 318, the DM client suppresses the Package 1 message. In other words, the DM client does not transmit the Package 1 message to the DM server. In step 320, the DM client receives Package 2 message from the DM server. Thereafter, the process ends and a conventional management phase of the DM session may be performed.

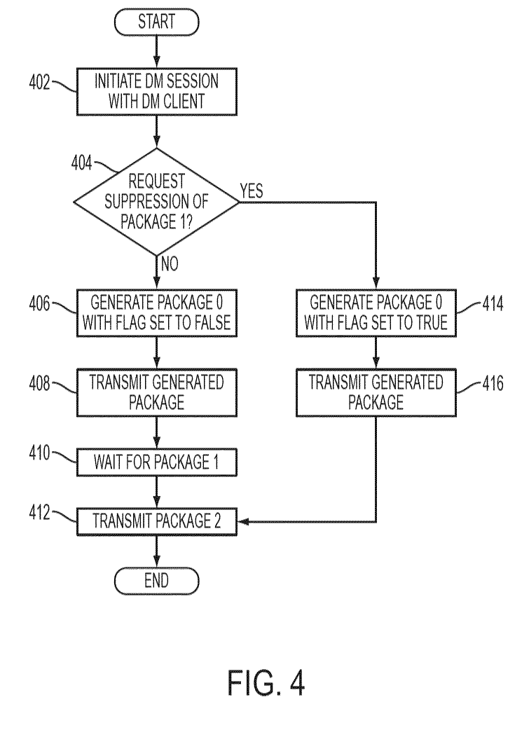

A method of selectively suppressing an OMA-DM Package 1 message at a DM server is described below with reference to FIG. 4.

FIG. 4 is a flowchart illustrating a method for selectively suppressing an OMA-DM Package 1 message at a DM server in communication system according to an exemplary embodiment of the present invention.

Referring to FIG. 4, in step 402, the DM server determines to initiate a DM session with one or more DM clients and begins a setup phase of the DM session according to an exemplary embodiment of the present invention. The determination may be made in response to a request to initiate a DM session received from a DM authority. In step 404, the DM server determines if a Package 1 message should be suppressed by the one or more DM clients in the DM session. The DM server may determine if the Package 1 message should be suppressed based on whether the DM session occurs in a broadcast mode, such as OMA DM-BCAST. When the DM session occurs in a broadcast mode, such as OMA DM-BCAST, messages transmitted from the DM server to the DM clients pass through a BCAST server. If it is determined that a Package 1 message should not be suppressed, the DM server proceeds to step 406. In step 406, the DM server generates a Package 0 message with the suppression flag of the Reserved field set to false (i.e. a value of ‘0’). In step 408, the DM server transmits the generated Package 0 message to the targeted DM client. In step 410, the DM server waits for a Package 1 message from the DM client. After the Package 1 message from the DM client is received, the DM server transmits a Package 2 message to the DM client in step 412. Thereafter, the process ends and a conventional management phase of the DM session may be performed.

Returning to step 404, if it is determined that a Package 1 message should be suppressed, the DM server proceeds to step 414. In step 414, the DM server generates a Package 0 message with a suppression flag of the reserve field set to true (i.e. a value of ‘1’). In step 416, the DM server transmits the generated Package 0 message to the targeted DM client and proceeds to step 412 to transmit a Package 2 message to the DM client. Here, the Package 2 message may be transmitted in step 412 after a delay from when the Package 0 message was transmitted. Thereafter, the process ends and a conventional management phase of the DM session may be performed.

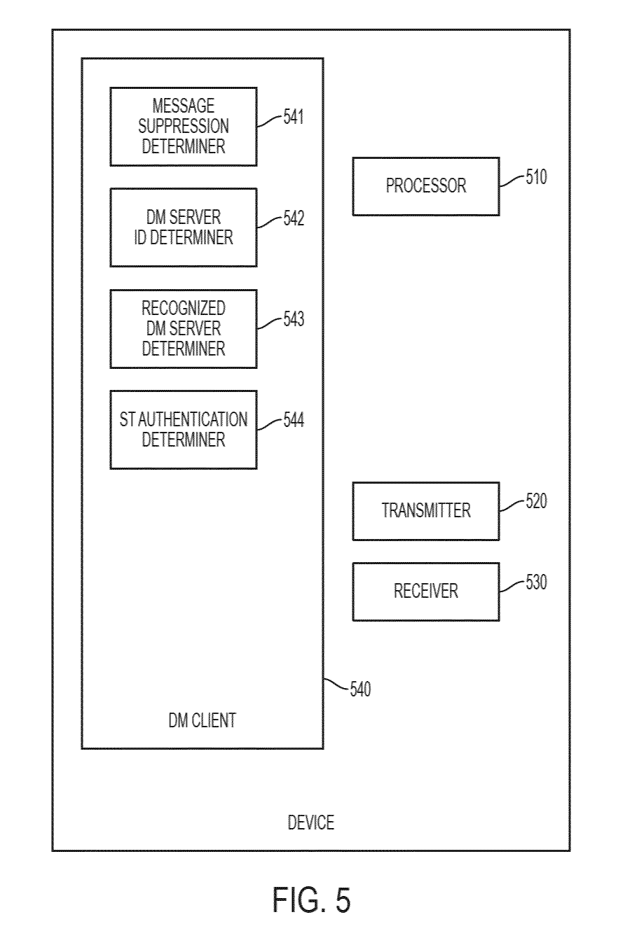

A structure of a device including a DM client for selectively suppressing an OMA-DM Package 1 message is described below with reference to FIG. 5.

FIG. 5 is a block diagram of a device including a DM client for selectively suppressing an OMA-DM Package 1 message in a communication system according to an exemplary embodiment of the present invention.

Referring to FIG. 5, the device includes a processor 510, a transmitter 520, a receiver 530, and a DM client 540. The DM client 540 includes a message suppression determiner 541, a DM server ID determiner 542, a recognized DM server determiner 543, and an ST authentication determiner 544. The DM client 540 may be implemented as code that is executed by the processor 510 or may be implemented as hardware. The term “code” may be used herein to represent one or more of executable instructions, operand data, configuration parameters, and other information stored in a memory of the device.

The processor 510 is used to process general operations of the device and may be used to execute the code of the DM client 540. The transmitter 520 transmits information from the device, which may include one or more messages from the DM client 540. The one or more messages from the DM client 540 may be an OMA-DM Package 1 message for a DM server. The receiver 530 receives information for the device, which may include one or more messages for the DM client 540. The one or more messages for the DM client 540 may be at least one of an OMA-DM Package 0 message and an OMA-DM Package 2 message from a DM server. Receipt of the Package 0 message from the DM server begins a setup phase of a DM session according to an exemplary embodiment of the present invention. Receipt of the Package 2 message from the DM server completes the setup phase of a DM session and thereafter a conventional management phase of the DM session may be performed.

The recognized DM server determiner 543, upon receiving a Package 0 message from a DM server, extracts a DM server ID from the received Package 0 message. The recognized DM server determiner 543 then determines if the DM server ID is a DM server ID that corresponds to a recognized DM server by determining if the DM server ID matches with an instance of a DM Account MO in a DM Tree. If the recognized DM server determiner 543 does not determine that the DM server ID corresponds to a recognized DM server, the received Package 0 message is ignored. If the recognized DM server determiner 543 determines that the DM server ID corresponds to a recognized DM server, the Package 0 message is processed.

The message suppression determiner 541 determines the value of the suppression flag, which is located in the Reserved field of the Package 0 message, that indicates whether to suppress a Package 1 message. If the suppression flag is set to false (e.g. ‘0’), the message suppression determiner 541 determines that the Package 1 message should not be suppressed. If the suppression flag is set to true (e.g. ‘1’), the message suppression determiner 541 determines that the Package 1 message should be suppressed.

The ST authentication determiner 544 determines if a value of an AAuthType node for the corresponding DM server in a DM Account MO is set to ‘TRANSPORT,’ if the message suppression determiner 541 determines that the Package 1 message should be suppressed. If the ST authentication determiner 544 determines that the value of the AAuthType node for the corresponding DM server is set to ‘TRANSPORT,’ the ST authentication determiner 544 determines that the Package 1 message will be suppressed. When the AAuthType node for the corresponding DM server is set to ‘TRANSPORT,’ it indicates that ST authentication is employed. If the ST authentication determiner 544 determines that the value of the AAuthType node for the corresponding DM server is not set to ‘TRANSPORT,’ the ST authentication determiner 544 determines that the Package 1 message will not be suppressed. When the AAuthType node for the corresponding DM server is not set to ‘TRANSPORT,’ it indicates that ST authentication is not employed.

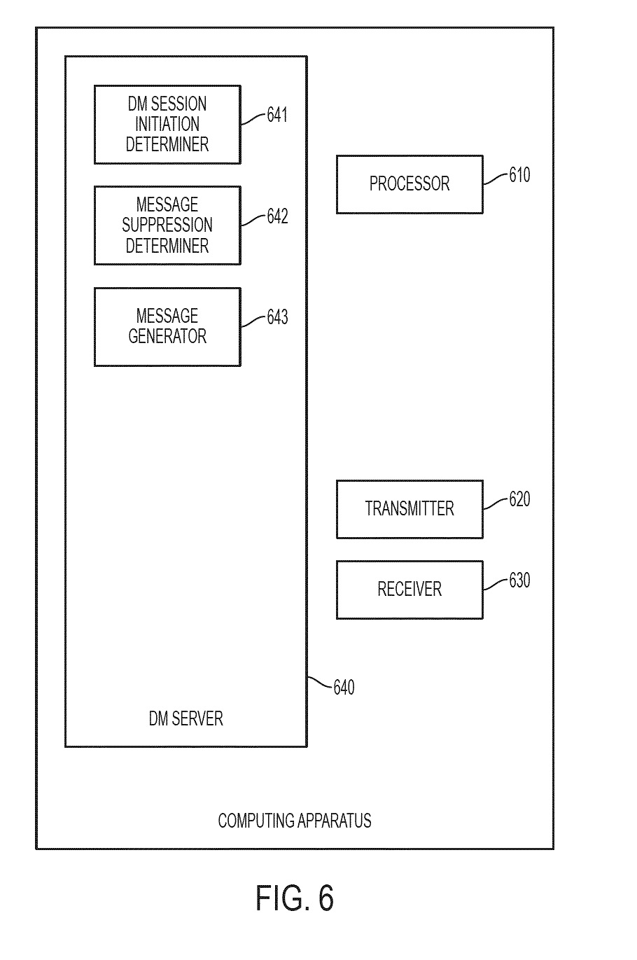

A structure of a computing apparatus including a DM server for selectively suppressing an OMA-DM Package 1 message is described below with reference to FIG. 6.

FIG. 6 is a block diagram of a computing apparatus including a DM server for selectively suppressing an OMA-DM Package 1 message in a communication system according to an exemplary embodiment of the present invention.

Referring to FIG. 6, the computing apparatus includes a processor 610, a transmitter 620, a receiver 630, and a DM server 640. The DM server 640 includes a DM session initiation determiner 641, a message suppression determiner 642, and a message generator 643. The DM server 640 may be implemented as code that is executed by the processor 610 or may be implemented as hardware. The term “code” may be used herein to represent one or more of executable instructions, operand data, configuration parameters, and other information stored in a memory of the computing apparatus.

The processor 610 is used to process general operations of the computing apparatus and may be used to execute the code of the DM server 640. The transmitter 620 transmits information from the computing apparatus, which may include one or more messages from the DM server 640. The information transmitted from the transmitter 620 may be directed to a DM client. Alternatively, in the context of DM-BCAST, information transmitted from the transmitter 620 may be directed to a BCAST server that relays the information to one or more DM clients. The one or more messages from the DM server 640 may be at least one of an OMA-DM Package 0 message and an OMA-DM Package 2 message for a DM client. The receiver 630 receives information for the computing apparatus, which may include one or more messages for the DM server 640. The one or more messages for the DM server 640 may be at least one of an OMA-DM Package 1 message from a DM client and a request to initiate a DM session from a DM authority. Transmission of the Package 0 message to the DM client begins a setup phase of a DM session according to an exemplary embodiment of the present invention. Transmission of the Package 2 message to the DM client completes the setup phase of a DM session and thereafter a conventional management phase of the DM session may be performed.

The DM session initiation determiner 641 determines to initiate a DM session with one or more DM clients. The determination may be made in response to a request to initiate a DM session received from a DM authority.

The message suppression determiner 642 determines if a Package 1 message should be suppressed by the one or more DM clients in the DM session. The message suppression determiner 642 may determine if the Package 1 message should be suppressed based on whether the DM session occurs in a broadcast mode, such as OMA DM-BCAST.

The message generator 643 generates a Package 0 message with the suppression flag of the Reserved field set to false (i.e. a value of ‘0’), if the message suppression determiner 642 determines that a Package 1 message should not be suppressed. The message generator 643 generates a Package 0 message with the suppression flag of the Reserved field set to true (i.e. a value of ‘1’), if the message suppression determiner 642 determines that the Package 1 message should be suppressed. The message generator 643 generates a Package 2 message. If the message generator 643 generates the Package 0 message with the suppression flag of the Reserved field set to false, the message generator 643 generates the Package 2 message after a Package 1 message is received from the DM client. If the message generator 643 generates the Package 0 message with the suppression flag of the Reserved field set to true, the message generator 643 generates the Package 2 message after the Package 0 message is generated, without waiting for the Package 1 message to be received. Here, the Package 2 message may be generated after a delay from when the Package 0 message was generated.

Accordingly, exemplary embodiments of the present invention provide a technique for suppressing a DM message in a communication system. More specifically, exemplary embodiments of the present invention provide a technique for selectively suppressing an OMA-DM Package 1 message in a communication system. The exemplary embodiments of the present invention provide a number of advantages. One advantage is that, in implementations of the exemplary embodiments of the present invention, changes to the conventional OMA-DM protocol are minimal. More specifically, changes to the OMA-DM protocol for the DM server are minimal because the DM server knows exactly when not to expect a Package 1 message since it was the DM server that set the suppression flag to true in the Package 0 message. Further, changes to the OMA-DM protocol for the DM client are minimal because the DM client only needs to check for the suppression flag in the Package 0 message and then verify that ST authentication is employed.

Another advantage of exemplary embodiments of the present invention is that there is no change in the overall flow of the conventional OMA-DM protocol. The DM server initiated DM sessions still start with a Package 0 message and there is no change in DM client initiated DM sessions. Yet another advantage is that a bit from the reserved field in the Package 0 message is used for the suppression flag. Yet another advantage is that the conditions under which the Package 1 message is suppressed do not result in any loss of significant information at the DM server.

Certain aspects of the present invention may also be embodied as computer readable code on a computer readable recording medium. A computer readable recording medium is any data storage device that can store data, which can be thereafter read by a computer system. Examples of the computer readable recording medium include Read-Only Memory (ROM), Random-Access Memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a Device Management (DM) client in a communication system, the method comprising:
receiving a message from a DM server;
determining if a response message should be suppressed based on the received message;
if it is determined that the response message should be suppressed, suppressing the response message by not transmitting the response message to the DM server;
if it is not determined that the response message should be suppressed, transmitting the response message to the DM server; and
receiving another message from the DM server.

2. The method of claim 1, wherein the message received from the DM server comprises an Open Mobile Alliance (OMA)-DM Package 0 message and the other message received from the DM server comprises an Open Mobile Alliance (OMA)-DM Package 2 message.

3. The method of claim 1, wherein the response message comprises an Open Mobile Alliance (OMA)-DM Package 1 message.

4. The method of claim 1, wherein the receiving of the message from the DM server comprises:
determining an IDentification (ID) of the DM server from the received message;
determining if the DM server is a recognized DM server;
if it is determined the DM server is a recognized DM server, processing the received message; and
if it is not determined that the DM server is a recognized DM server, ignoring the received message.

5. The method of claim 4, wherein the determining if the DM server is a recognized DM server comprises:
determining if the ID of the DM server matches with an instance of a DM Account Management Object (MO) in a DM Tree;
if it is determined that the ID of the DM server matches with the instance of the DM Account MO in the DM Tree, determining that the DM server is a recognized DM server; and
if it is not determined that the ID of the DM server matches with the instance of the DM Account MO in the DM Tree, determining that the DM server is not a recognized DM server.

6. The method of claim 1, wherein the determining if the response message should be suppressed comprises:
determining if the received message includes an indication that the response message should be suppressed; and
if it is not determined that the received message includes an indication that the response message should be suppressed, determining that the response message should not be suppressed.

7. The method of claim 6, wherein the indication that the response message should be suppressed is located in a Reserved field of the received message.

8. The method of claim 6, wherein the indication that the response message should be suppressed is based on a value of a single bit in the received message.

9. The method of claim 6, wherein the determining if the response message should be suppressed further comprises:
if it is determined that the received message includes an indication that the response message should be suppressed, determining if Secure Transport (ST) authentication is used;
if it is determined that ST authentication is used, determining that the response message should be suppressed; and
if it is not determined that ST authentication is used, determining that the response message should not be suppressed.

10. The method of claim 9, wherein the determining if ST authentication is used comprises:
determining if an AAuthType node for the DM server in a DM Account Management Object (MO) is set to ‘TRANSPORT’, and
if it is determined that the AAuthType node for the DM server in the DM Account MO is set to ‘TRANSPORT’, determining that ST authentication is used.

11. The method of claim 1, wherein the message received from the DM server and the other message received from the DM server are received from the DM server via a BCAST server.

12. A method for operating a Device Management (DM) server in a communication system, the method comprising:
determining to initiate a DM session with a DM client;
determining if the DM client should be instructed to suppress a response message;
if it is determined that the DM client should be instructed to suppress a response message, generating a message that includes an instruction for the DM client to suppress the response message;
if it is not determined that the DM client should be instructed to suppress a response message, generating a message that does not include an instruction for the DM client to suppress the response message; and
transmitting the generated message.

13. The method of claim 12, wherein the generated message comprises an Open Mobile Alliance (OMA)-DM Package 0 message.

14. The method of claim 12, wherein the response message comprises an Open Mobile Alliance (OMA)-DM Package 1 message.

15. The method of claim 12, wherein the determining if the DM client should be instructed to suppress the response message comprises:
determining if the DM session is going to be in a broadcast;
if it is determined that the DM session is going to be in a broadcast;
determining that the DM client should be instructed to suppress the response message; and
if it is not determined that the DM session is going to be in a broadcast;
determining that the DM client should not be instructed to suppress the response message.

16. The method of claim 12, wherein the indication that the response message should be suppressed is located in a Reserved field of the generated message.

17. The method of claim 12, wherein the indication that the response message should be suppressed is based on a value of a single bit in the generated message.

18. The method of claim 12, further comprising:
if it is not determined that the DM client should be instructed to suppress the response message, waiting for the response message to be received after the transmitting of the generated message; and
after receiving the response message, transmitting another message to the DM client.

19. The method of claim 18, wherein the other message transmitted to the DM client comprises an Open Mobile Alliance (OMA)-DM Package 2 message.

20. The method of claim 12, further comprising:
if it is determined that the DM client should be instructed to suppress the response message, transmitting another message to the DM client after the transmitting of the generated message, without waiting for the response message to be received.

21. The method of claim 20, wherein the other message transmitted to the DM client comprises an Open Mobile Alliance (OMA)-DM Package 2 message.

22. The method of claim 12, wherein the generated message is transmitted to a BCAST server for transmission to the DM client.

23. A Device Management (DM) client apparatus for use in a communication system, the apparatus comprising:
a receiver for receiving one or more messages from a DM server;
a transmitter for transmitting a response message to the a DM server, wherein the response message is transmitted in response to a message received from the DM server; and
a message suppression determiner for determining if the response message should be suppressed based on the received message,
wherein if the message suppression determiner determines that the response message should be suppressed, the transmitter does not transmit the response message to the DM server, and if the message suppression determiner does not determine that the response message should be suppressed, the transmitter transmits the response message to the DM server.

24. The apparatus of claim 23, wherein the message received from the DM server that the message suppression determiner uses to determine if the response message should be transmitted comprises an Open Mobile Alliance (OMA)-DM Package 0 message.

25. The apparatus of claim 23, wherein the response message comprises an Open Mobile Alliance (OMA)-DM Package 1 message.

26. The apparatus of claim 23, further comprising:
a DM server IDentification (ID) determiner for determining an ID of the DM server from the received message; and
a recognized DM server determiner for determining if the DM server is a recognized DM server,
wherein, if the recognized DM server determiner determines that the DM server is the recognized DM server, the received message is processed, and if the recognized DM server determiner does not determine that the DM server is a recognized DM server, the received message is ignored.

27. The apparatus of claim 26, wherein the recognized DM server determiner determines that the DM server is the recognized DM server if the DM server ID matches with an instance of a DM Account Management Object (MO) in a DM Tree.

28. The apparatus of claim 23, wherein the message suppression determiner determines that the response message should be suppressed if the received message includes an indication that the response message should be suppressed.

29. The apparatus of claim 28, wherein the indication that the response message should be suppressed is located in a Reserved field of the received message.

30. The apparatus of claim 28, wherein the indication that the response message should be suppressed is based on a value of a single bit in the received message.

31. The apparatus of claim 28, further comprising:
a Secure Transport (ST) authentication determiner for determining if ST authentication is used for the DM server that transmitted the received message,
wherein the message suppression determiner determines that the response message should be suppressed if the received message includes the indication that the response message should be suppressed and if the ST authentication determiner determines that ST authentication is used.

32. The apparatus of claim 31, wherein the ST authentication determiner determines that ST authentication is used if an AAuthType node for the DM server in a DM Account Management Object (MO) is set to ‘TRANSPORT’.

33. The apparatus of claim 23, wherein the one or more messages received from the DM server are received from the DM server via a BCAST server.

34. A Device Management (DM) server apparatus for use in a communication system, the apparatus comprising:
a DM session initiation determiner for determining to initiate a DM session with a DM client;
a receiver for receiving a response message from the DM client;
a message suppression determiner for determining if the DM client should be instructed to suppress the response message;
a message generator for generating one or more messages for transmission to the DM client; and
a transmitter for transmitting the generated one or more messages to the DM client,
wherein if the message suppression determiner determines that the DM client should be instructed to suppress the response message, the message generator generates a message that includes an instruction for the DM client to suppress the response message, and if the message suppression determiner does not determine that the DM client should be instructed to suppress the response message, the message generator generates a message that does not include an instruction for the DM client to suppress the response message.

35. The apparatus of claim 34, wherein the generated message that includes the instruction for the DM client to suppress the response message comprises an Open Mobile Alliance (OMA)-DM Package 0 message.

36. The apparatus of claim 34, wherein the response message comprises an Open Mobile Alliance (OMA)-DM Package 1 message.

37. The apparatus of claim 34, wherein the message suppression determiner determines that the DM client should be instructed to suppress the response message if the DM session is going to be in a broadcast.

38. The apparatus of claim 34, wherein the indication that the response message should be suppressed is located in a Reserved field of the generated message.

39. The apparatus of claim 34, wherein the indication that the response message should be suppressed is based on a value of a single bit in the generated message.

40. The apparatus of claim 34, wherein if the message suppression determiner does not determine that the DM client should be instructed to suppress the response message, the receiver receives the response message after the generated message is transmitted, and
further wherein after the receiver receives the response message, the transmitter transmits another message to the DM client that was generated by the message generator.

41. The apparatus of claim 40, wherein the other message transmitted to the DM client comprises an Open Mobile Alliance (OMA)-DM Package 2 message.

42. The apparatus of claim 34, wherein if the message suppression determiner determines that the DM client should be instructed to suppress the response message, the transmitter transmits another message to the DM client that was generated by the message generator, without waiting for the response message to be received.

43. The apparatus of claim 42, wherein the other message transmitted to the DM client comprises an Open Mobile Alliance (OMA)-DM Package 2 message.

44. The apparatus of claim 34, wherein the generated one or more messages are transmitted to a BCAST server for transmission to the DM client.
